(19) United States
(12) Patent Application Publication
(10) Pub. No.: US 2006/0103887 A1
(43) Pub. Date: May 18, 2006

(54) Printer and print

(75) Inventors: Jun Enomoto, Kanagawa (JP); Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/281,589

(22) Filed: Nov. 18, 2005

(30) Foreign Application Priority Data
Nov. 18, 2004 (JP) 2004-334358
Dec. 13, 2004 (JP) 2004-359835

(51) Int. Cl. H04N 1/23

(52) U.S. Cl. 358/296

(57) ABSTRACT

A printer, including: an acquisition unit acquiring image data; a display device displaying a finish prediction image of the image data; an adjustment part adjusting the finish prediction image; an image processing part that generates image data for output by executing image processing in which adjustment by said adjustment part is reflected on the image data; a back print information edit-and-output part that generates first back print information containing information of adjustment by said adjustment part and second back print information corresponding to image processing by said image processing part, and edits the first and second back print information to output it as back print recording information; an image forming unit that reproduces a visible image on a recording medium according to the image data for output; and a back printer performing back printing corresponding to the back print recording information on a back surface of the recording medium.

The entire contents of literatures cited in this specification are incorporated herein by reference.

### BACKGROUND OF THE INVENTION

The present invention relates to a technical field of a printer, which mainly creates photographic prints, and prints. More specifically, the present invention relates to prints, with which it becomes possible for a customer or an operator to know image processing carried out on images of the prints with ease and therefore when high-grade image processing, such as red eye correction, has been performed, it becomes possible to have the customer or the operator recognize that the high-grade image processing has been performed with ease, and a printer that is capable of outputting the prints.

Also, the present invention relates to a printer with which it becomes possible to clearly express on prints that high-grade image processing, such as red eye correction, has been performed on images of the prints and it also becomes possible to shorten a time (first print time) that is required before the first print is outputted.

In recent years, a digital photoprinter has been put into practical use which photoelectrically reads images recorded on a film, converts the read images into digital signals, generates image data for recording by carrying out various kinds of image processing, and outputs prints by exposing a photosensitive material with recording light modulated in accordance with the image data.

In such a digital photoprinter, images photographed on a film are photoelectrically read and are converted into digital image data, and processing of the images and exposure of a photosensitive material are performed using the digital image data. Therefore, it becomes possible to create prints not only from images photographed on a film but also from images (image data) photographed with a digital camera or the like.

Also, as described above, in the digital photoprinter, images are dealt with as digital image data, so it becomes possible to perform image processing (correction and/or adjustment of the images) through processing of the image data.

Therefore, it becomes possible to perform image processing, such as color/density correction, gradation correction, and color saturation correction, with an extremely high degree of flexibility as compared with a case of a conventional analog exposure printer (printer that exposes a photosensitive material (printing paper) with projection light from a film), which makes it possible to reproduce high-quality images with stability even in the case of so-called overexposure, underexposure, backlight scenes, and the like.

In addition, with the digital photoprinter, it becomes possible to perform, through processing of image data, image processing, such as sharpness processing, dodging processing (addition of a dodging effect through adjustment of an image dynamic range in which a halftone is maintained), red eye correction, deteriorated marginal luminosity correction (correction of density unevenness due to the deteriorated marginal luminosity of a photographing lens), aberration correction (correction of distortion due to aberration of a photographing lens), scratch removal processing (correction of defective pixels due to scratches in a film or a photographing lens, dusts adhering thereto, and/or the like), which requires an operator to have a highly sophisticated skill, is extremely difficult, or is substantially impossible with an analog exposure printer.

The color/density correction, the gradation correction, the color saturation correction, and the like are the minimum required processing to complete appropriate images. That is, it is possible to obtain finished prints at a level of products merely by performing these image processing.

In contrast to this, the sharpness processing, the dodging processing, the red eye correction, the deteriorated marginal luminosity correction, the aberration correction, the scratch removal processing, and the like are, so to speak, high-grade image processing that requires a more sophisticated computation and analysis. Accordingly, by performing these image processing, it becomes possible to output prints on which high-quality images have been reproduced in which full use of advantages of digital exposure has been made. In order to execute the image processing, however, a long processing time is required and a sophisticated system is necessary. In particular, in the case of the red eye correction and the scratch removal processing, analysis using high-resolution images corresponding to image data for output is required and a long processing time is necessary.

However, it is impossible for a customer (person who requested creation of photographic prints) to know from finished prints which image processing has been carried out on images reproduced from photographed images.

Therefore, even when images having high quality as compared with a case of a general lab system or processing system have been finished by performing the high-grade processing by spending a long time and using a sophisticated image processing system, it is extremely difficult to have the customer notice and appreciate the fact.

Also, in an image recording apparatus such as a printer or a copier that uses plain paper, it is more preferable that a time (referred to as the “first print time”) that is required before the first print (recording paper) is outputted after start of an operation is shorter. In a like manner, also in the case of the photoprinter, from the viewpoint of productivity, it is preferable that the first print time is reduced as much as possible.

When the high-grade image processing that takes a long processing time is performed, however, the first print time is conversely elongated.

Here, print creation processing and the first print time in a conventional digital photoprinter will be described in brief.

FIG. 12 is a conceptual diagram for explanation of a schematic construction of a conventional digital photoprinter 100 and a flow of print creation processing therein. Generally, a photoprinter, such as a mini-lab system, includes an input apparatus 102 that acquires image data and creates print image data and an output apparatus 104 that creates prints from the image data supplied from the input apparatus 102 and outputs the created prints, and performs print processing through cooperation between the input apparatus 102 and the output apparatus 104.

When prints are created from images photographed on a film, the input apparatus 102 first performs prescan with respect to the film set in a scanner. Next, the input apparatus 102 generates inspection images (finish prediction images) from prescan image data and displays the inspection images on an inspection screen. Following this, inspection is conducted on the inspection images and correction of colors, densities, and/or the like is performed as necessary. When images (images for obtaining print images) have been determined through input of “inspection OK” (output instruction), the input apparatus 102 next performs fine scan and obtains fine scan image data. Then, the input apparatus 102 generates “print image data” by performing image processing on the fine scan image data under correction conditions determined through the inspection, and outputs the print image data to the output apparatus 104.

On the other hand, when prints are created from images (image data) photographed with a digital camera or the like, the input apparatus 102 captures the image data, generates inspection images at low resolution from the captured image data, and displays the inspection images on the inspection screen. Then, inspection is carried out on the inspection images and correction of colors, densities, and/or the like is performed as necessary. When images have been determined through input of inspection OK (output instruction), the input apparatus 102 then generates “print image data” by performing image processing on the captured image data under correction conditions determined through the inspection and outputs the print image data to the output apparatus 104.

In addition, in both of the case where image data is obtained from a film and the case where image data is captured, once images have been determined through inspection, the input apparatus 102 generates “back print information” for performing back printing (for recording back prints) based on correction information and outputs the back print information to the output apparatus 104. The back print information includes information showing frame numbers or image file names, color/density correction information (information as to color/density correction made using CMYD keys), and the like.

When both of the “back print information” and the “print image data” have been obtained, the output apparatus 104 starts a series of print output operations. That is, the output apparatus 104 draws out paper (print sheet, printing paper) from a paper magazine and cuts the drawn-out paper into a print size. Following this, the output apparatus 104 performs back printing on the back surface (non-photosensitive surface) of the paper based on the “back print information” and performs scan-exposure on the front surface of the paper based on the “print image data”. Then, the output apparatus 104 performs development processing and dry processing (not shown) on the paper and outputs it as finished prints.

As described above, in the conventional photoprinter, after having received both of the “back print information” and the “print image data”, the output apparatus 104 starts the print output operations, so as a time necessary to create the “back print information” and the “print image data” is elongated, start of the print sheet supply is delayed and the first print time is elongated. Therefore, when high-grade processing that requires a long processing time is performed, a long time is taken for the creation of the “print image data” and therefore the first print time is elongated.

Also, even when high-quality images have been finished by performing the high-grade processing by elongating the first print time in the manner described above, it is extremely difficult to have a customer appreciate a result of the processing, as described above.

As a method of having a customer recognize that prints have been outputted by reproducing high-quality images through image processing and appreciate a result of the processing, in JP 2003-205660 A, a print method is described with which an image is selected from among images corresponding to a customer's order, and a print in which the image has been digitally enhanced (qualitatively improved/upgraded) and a print in which the image is not enhanced are outputted.

With the method described in JP 2003-205660 A, it becomes possible to have the customer recognize that prints have been outputted by reproducing high-quality images through image processing and appreciate a result of the processing.

With the print method, however, it becomes possible to have the customer notice the effect of the image processing executed on the selected image to some extent, however, it is impossible to have the customer notice the effect of the image processing carried out on other images. Therefore, when the image processing performed on the images differs from image to image and it is desired to have the customer notice the effect of the image processing performed on each image and appreciate the effect of the image processing, it becomes necessary to output two prints for each image, that is, the number of prints outputted is doubled.

Also, with the print method, it is impossible for the customer to know which image processing has been performed on each image in a concrete manner.

Further, like in the case described above, when prints of the enhanced images are outputted, the first print time is elongated.

### SUMMARY OF THE INVENTION

The present invention has been made in order to solve the problems of the conventional techniques described above and a first object of the present invention is to provide prints, which have been outputted by performing various kinds of image processing on images photographed on a photographic film or images photographed with a digital camera or the like and with which it becomes possible to have a customer know the image processing executed on each image or the executed image processing as well as the contents thereof with ease, and a printer with which it becomes possible to output the prints.

Also, a second object of the present invention is to provide prints, with which even when sophisticated image processing that requires a long processing time is performed, it becomes possible to shorten the first print time and it also becomes possible to have a customer know the sophisticated image processing executed to obtain a high-quality image in each print or the executed image processing as well as a processing result thereof with ease, and a printer with which it becomes possible to output the prints.

In order to attain the above object, a first aspect of the present invention provides a printer including:

an acquisition unit that acquires image data;

a display device that displays a finish prediction image of the image data;

an adjustment part that adjusts the finish prediction image;

an image processing part that generates image data for output by executing image processing in which an adjustment by said adjustment part is reflected on the image data;

a back print information edit-and-output part that generates first back print information containing information as to an adjustment by said adjustment part and second back print information that is information corresponding to image processing executed by said image processing part, edits the first back print information and the second back print information to generate back print recording information, and outputs the back print recording information;

an image forming unit that reproduces a visible image on a recording medium in accordance with the image data for output; and

a back printer that performs back printing corresponding to the back print recording information on a back surface of the recording medium.

Moreover, in the printer of the present invention, said image processing part has a function of executing at least one of red eye correction, correction of an image defective portion, correction of aberration ascribable to a photographing lens, correction of deteriorated marginal luminosity ascribable to the photographing lens, trimming, soft-focus processing and cross-filter processing, in addition to a function of executing gradation correction, color/density correction, color saturation correction, sharpness processing, graininess suppression processing and dodging processing, and wherein the second back print information is information concerning at least one of the sharpness processing, the graininess suppression processing, the dodging processing, the red eye correction, the image defective portion correction, the aberration correction, the deteriorated marginal luminosity correction, the trimming, the soft-focus processing and the cross-filter processing.

Moreover, the printer of the present invention further including: a selection part that collectively selects execution/non-execution of every function set in said image processing part among the red eye correction, the image defective portion correction, the aberration correction, and the deteriorated marginal luminosity correction. Moreover, the printer of the present invention, further including:

Moreover, the printer of the present invention further including: a selection part that individually selects execution/non-execution of the red eye correction, the image defective portion correction, the aberration correction, and the deteriorated marginal luminosity correction.

Moreover, in the printer of the present invention, said back printer prints information showing that an image processing has been executed based on the second back print information contained in the back print recording information.

Moreover, in the printer of the present invention, said back printer prints information that shows a processing content of at least one of the image processing executed, in addition to the information showing that the image processing has been executed, based on the second back print information contained in the back print recording information.

Moreover, in the printer of the present invention, said back printer prints a content which is different depending upon a kind of the image processing executed as the information that shows a processing content based on the second back print information contained in the back print recording information.

Moreover, the printer of the present invention further including:

a print information acquisition unit that acquires print information containing information showing a size and number of prints to be outputted;

a determination part that determines an image to be outputted; and

a supply part that acquires the information showing a size and number of prints acquired by said print information acquisition unit and supplies a corresponding recording medium, in response to image determination by said determination part,

wherein said image processing part generates the image data for output from the image data in response to the image determination by said determination part.

Moreover, in the printer of the present invention, said determination part is a predetermined output instruction part, and wherein an image is determined when an output instruction has been issued by the output instruction part after displaying of the finish prediction image.

Moreover, in the printer of the present invention, said back print information edit-and-output part generates the second back print information in accordance with a result of the image processing executed by said image processing part.

Moreover, the printer of the present invention further including: a selection part that selects image processing executed on the image data with reference to at least one of the print information acquired by said print information acquisition unit and information concerning the image, wherein said back print information edit-and-output part generates the second back print information in accordance with a result of selection by said selection part.

Moreover, in the printer of the present invention, the information concerning the image contains at least one of photographing information, camera information, and image data.

Moreover, in the printer of the present invention, the print information contains information showing designation of image processing by said image processing part.

A second aspect of the present invention provides a print including:

a front surface on which an image has been reproduced; and

a back surface on which information corresponding to image processing executed on the image has been printed, wherein the information corresponding to image processing is information concerning at least one of sharpness processing, graininess suppression processing, dodging processing, red eye correction, image defective portion correction, aberration correction, deteriorated marginal luminosity correction, trimming, soft-focus processing, and cross-filter processing.

Moreover, in the print of the present invention, the information corresponding to image processing contains information showing that the image processing has been executed on the image.

Moreover, in the print of the present invention, the information corresponding to image processing contains information showing a processing content of at least one of the image processing executed, in addition to the information showing that the image processing has been executed on the image.

Moreover, in the print of the present invention, the information showing a processing content is different depending upon a kind of the image processing executed on the image.

According to the printer of the present invention, with the construction described above, it becomes possible to output prints with which it becomes possible to have a customer know image processing executed for each print with ease.

Also, according to the prints of the present invention, it becomes possible to give a customer information about the image processing executed on the prints with ease through back printing.

Therefore, according to the present invention, when prints have been outputted by performing high-grade processing such as red eye correction, dust/scratch removal processing and/or the like, it becomes possible to have a customer who ordered the prints recognize that images have been outputted by performing the high-grade image processing and it becomes possible to achieve high-value-added images (products), differentiation from images for which no high-grade processing has been performed, differentiation from other stores such as laboratory stores, price maintenance with respect to other stores, acquiring and ensuring of customers, and the like. Also, at the time of creation of reprints in accordance with customer complaints or the like, it becomes possible to know which image processing has been performed for previous prints with ease at a laboratory shop, so it becomes possible to correct problems accurately and output required reprints with reliability.

In addition, according to the present invention, with the construction described above, when prints have been outputted by performing various kinds of image processing on images photographed on a photographic film or images photographed with a digital camera or the like, even when sophisticated image processing that requires a long processing time is performed, it becomes possible to shorten the-first print time and it also becomes possible to output prints with which it becomes possible to have a customer know the sophisticated image processing executed to output a high-quality image in each print or the executed image processing as well as a processing result thereof with ease.

More specifically, according to the present invention, when images for obtaining print images have been determined, print sheet supply is started without waiting for both of “back print information” and “print image data” to be obtained. With this construction, even when sophisticated image processing, such as red eye correction, dust/scratch removal processing, aberration correction, and/or deteriorated marginal luminosity correction requiring a long processing time is carried out, it becomes possible to shorten the first print time. In addition, with a construction in which information as to the high-grade image processing is reflected in the back print information, when prints have been outputted by executing the sophisticated image processing, it becomes possible to provide the effect described above such as making it possible to have a customer who ordered the prints recognize that images have been outputted by performing the high-grade image processing.

That is, according to the present invention, it becomes possible to provide mutually opposing effects of outputting high-quality images through the high-grade processing and shortening the first print time, and it also becomes possible to have a customer notice the effect of the high-grade processing.

### BRIEF DESCRIPTION OF THE DRAWINGS

In the accompanying drawings:

FIG. 1 is a block diagram showing a schematic construction of a printer of a first embodiment according to the present invention;

FIG. 2 is a block diagram showing a construction of an image processing unit or a DIC in the printer shown in FIG. 1;

FIG. 3 is a print creation processing flow diagram in the first embodiment;

FIG. 4 is an image processing flow diagram in the first embodiment;

FIG. 5A is a red eye correction processing flow diagram;

FIG. 5B is a scratch removal processing flow diagram;

FIG. 5C is a back print recording information edit processing flow diagram;

FIG. 6 is a block diagram showing a schematic construction of a printer of a second embodiment according to the present invention;

FIG. 7 is a print creation processing flow diagram in the second embodiment;

FIG. 8 is a print creation processing flow diagram in a printer of a third embodiment according to the present invention;

FIGS. 9A, 9B, and 9C are each a flow diagram showing a second back print information generation method in the third embodiment;

FIG. 10 is a print creation processing flow diagram in a printer of a fourth embodiment according to the present invention;

FIGS. 11A and 11B show an example of the print according to the present invention, in which FIG. 11A shows the front surface of the example, and FIG. 11B shows the back surface thereof; and

FIG. 12 is a block diagram for explanation of a schematic construction and a print creation processing flow of a conventional digital photoprinter.

### DETAILED DESCRIPTION OF THE PREFERRED EMBODIMENTS

Hereinafter, the printer and the print according to the present invention will be described in detail based on preferred embodiments illustrated in the accompanying drawings.

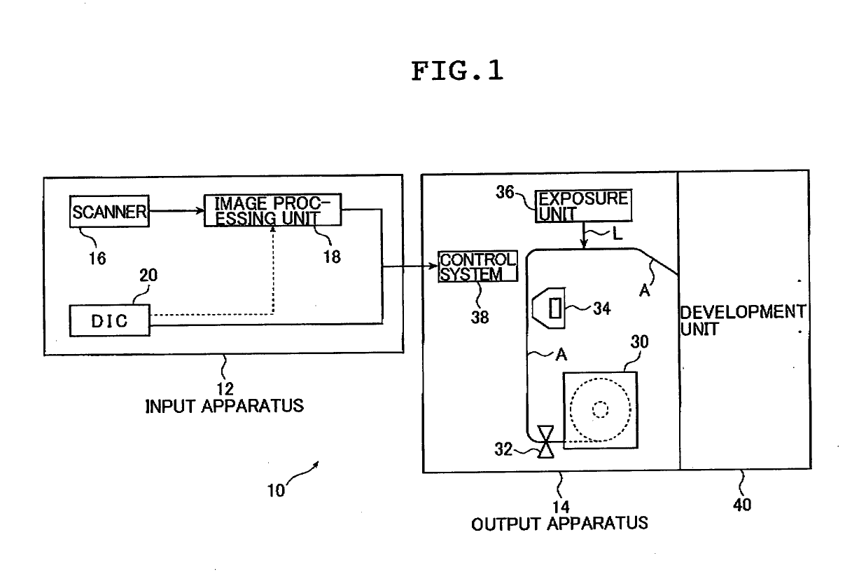

FIG. 1 shows a schematic construction of the printer of a first embodiment according to the present invention.

A printer 10 in an illustrated embodiment obtains images (image data) photographed on a film or images (image data) photographed with a digital camera, generates print images (image data for output) by performing image processing on the images, exposes a photosensitive material (printing paper) that is print sheets in accordance with the print images, and outputs the photosensitive material as (photographic) prints. That is, the printer 10 is the digital photoprinter described above and includes an input apparatus 12 and an output apparatus 14.

The input apparatus 12 includes a scanner 16, an image processing unit 18, and a digital image controller (DIC) 20, for instance. Note that the input apparatus 12 may include only the scanner 16 and the image processing unit 18, may include only the DIC 20, or may include only the image processing unit 18 and the DIC 20.

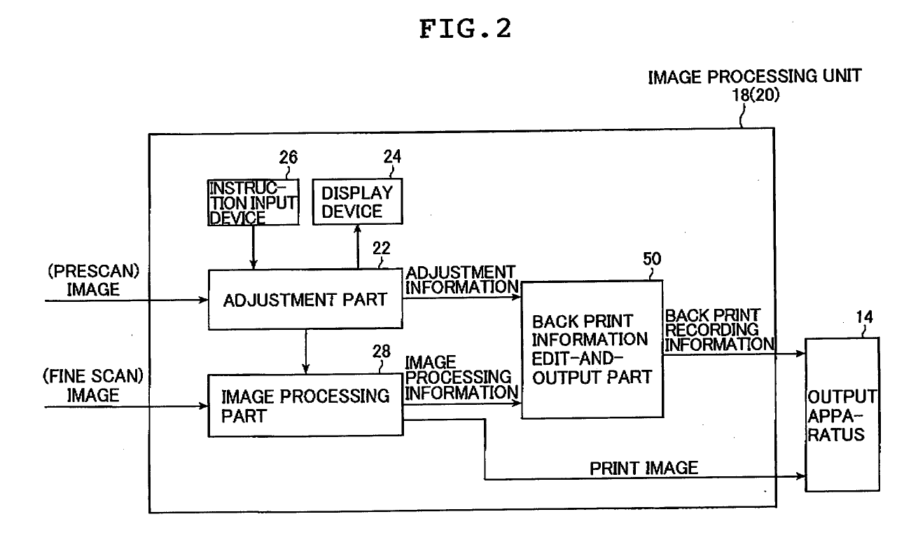

In addition, in the image processing unit 18 or the DIC 20 of the input apparatus 12, a back print information edit-and-output part is arranged. FIG. 2 shows a construction of the image processing unit 18 or the DIC 20. Note that the back print information edit-and-output part 50 may be arranged in both of the image processing unit 18 and the DIC 20, or may be arranged in only one of the image processing unit 18 and the DIC 20 and necessary information is exchanged therebetween. Alternatively, the back print information edit-and-output part 50 may be arranged in the input apparatus 12 as a site that is completely independent from the image processing unit 18 and the DIC 20. In the following descriptions, a form in which each of the image processing unit 18 and the DIC 20 includes the back print information edit-and-output part 50, will be explained as an example.

The scanner 16 is a known film scanner that emits reading light toward a (photographic) film and reads images photographed on the film by photoelectrically reading projection light from the film.

The image processing unit 18 has an image processing function (image processing part 28) that obtains print images by performing image processing on image data generated through reading by the scanner or image data supplied from the outside, and outputs the print images to the output apparatus 14. In addition, the image processing unit 18 also has a display function (display device 24) that displays inspection images (finish prediction images (simulation images)) and an inspection function including an adjustment part 22 for making an adjustment of the colors, densities, and the like of the images, and an instruction input device 26.

The DIC 20 acquires images (image data) photographed with a photographing apparatus, such as a digital camera or a mobile telephone having a photographing function, from the photographing apparatus or a storage medium such as a Smart Media™ or a PC Card™ in which the images photographed with the photographing apparatus are stored, or through various communication networks to which a personal computer, a print order reception terminal, and the like are connected, for instance. Then, the DIC 20 obtains print images by performing image processing and outputs the print images to the output apparatus 14.

In the illustrated embodiment, the DIC 20 has an image processing function (image processing part 28) and a display/inspection function (display device 24, adjustment part 22, and instruction input device 26) that are the same as those of the image processing unit 18. Depending on the performance of the DIC 20 or the construction of the printer 10 (system), however, the DIC 20 may supply acquired images to the image processing unit 18 as they are without processing the images. In this case, print images are obtained by performing image processing and inspection at the image processing unit 18 and are supplied to the output apparatus 14. Alternatively, the DIC 20 may perform image processing on the acquired images and supply the processed images to the image processing unit 18. In this case, print images are obtained by performing inspection at the image processing unit 18 and are supplied to the output apparatus 14. Still alternatively, print images may be obtained by performing inspection at the DIC 20 and may be supplied to the output apparatus 14 through the image processing unit 18.

Also, to the DIC 20, an order reception apparatus that is installed at a counter of a laboratory store, on a street, or the like, reads images from a photographing apparatus or a recording medium, accepts print order instructions, associates the images and order information with each other, and outputs the associated images and information may be connected through a communication network or the like.

The back print information edit-and-output part 50 acquires information showing frame numbers or the like of images, information as to image correction made at the time of inspection, and information about image processing carried out on the images, generates first back print information corresponding to back prints in the case of ordinary photographic prints and second back print information corresponding to the image processing carried out on the images from the acquired information, generates back print recording information for recording back prints by editing the first and second back print information, associates the back print recording information with corresponding print images, and outputs the information associated with print images to the output apparatus 14.

The back print information edit-and-output part 50 will be described in detail later.

The output apparatus 14 draws out a long photosensitive material (printing paper) wound in a roll form from a magazine 30, cuts the drawn-out photosensitive material into a print size using a cutter 32, and performs back printing (records back prints) on the back surface (non-photosensitive surface) of a cut photosensitive material A with a back printer 34. Note that as the back printer 34, various printers, such as a dot impact printer, an ink jet printer, and a thermal transfer printer, are usable so long as there occurs no degradation due to development processing.

After the back printing being performed on the photosensitive material A, the output apparatus 14 brings a light beam L (recording light) modulated in accordance with print images supplied from the input apparatus 12 and emitted from an exposure unit 36 into being incident at a predetermined exposure position by deflecting the light beam L in a main scanning direction, and also conveys the photosensitive material A in a sub-scanning direction orthogonal to the main scanning direction while setting the photosensitive material A at the exposure position, thereby two-dimensionally scanning and exposing the photosensitive material A with the light beam L and recording latent images.

Following this, the output apparatus 14 sends the photosensitive material A on which the latent images have been recorded to a development unit 40. At the development unit 40, development processing is performed. More specifically, each processing of development, bleaching/fixation, and rinsing is performed on the photosensitive material A in succession. Then, the developed photosensitive material A is dried and is outputted as finished (photographic) prints. Finally, the finished prints are sorted by a sorter (not shown) every -unit of print orders.

A control system 38 controls the operations described above of the output apparatus 14.

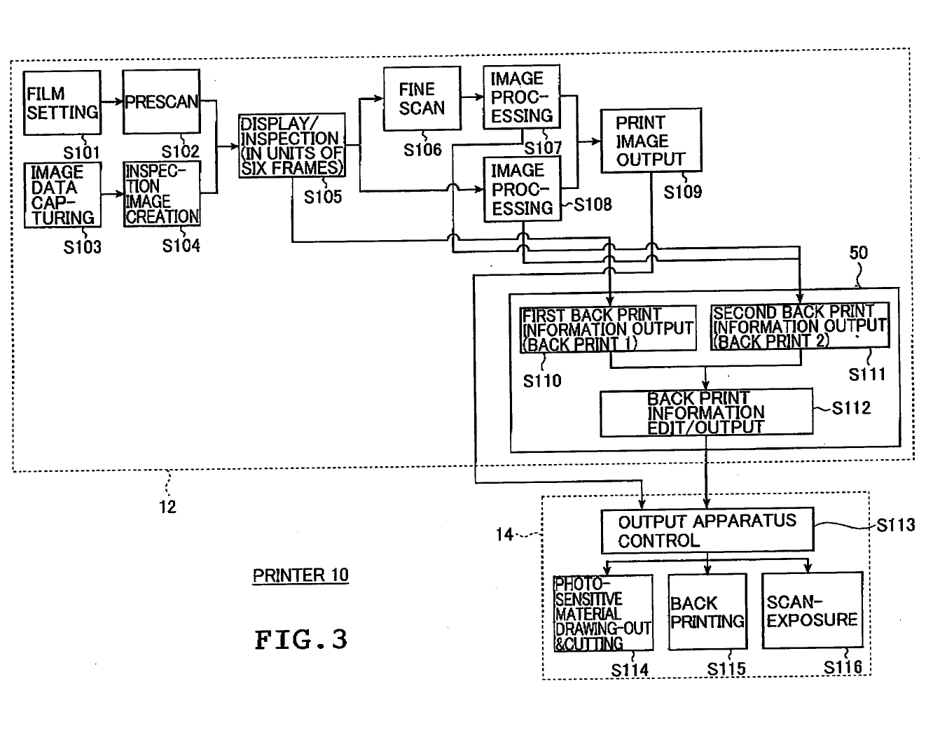

Hereinafter, the back print information edit-and-output part 50 and the present invention will be described in more detail by explaining an action of the printer 10 with reference to FIGS. 2 and 3.

FIG. 3 shows a flow of print creation processing in the printer 10. In FIG. 3, processing at the input apparatus 12 is illustrated in a space surrounded by a broken line given reference numeral 12 and processing at the output apparatus 14 is illustrated in a space surrounded by a broken line given reference numeral 14. Also, among the processing at the input apparatus 12, processing at the back print information edit-and-output part 50 is illustrated in a space surrounded by a solid line given reference numeral 50. Further, processing at the scanner 16, processing at the image processing unit 18, and processing at the DIC 20 are collectively illustrated as the processing at the input apparatus 12.

In the case of print creation from a film, the film is set at a predetermined position (film carrier) of the scanner 16 (step S101) and a start instruction is issued. In response to the instruction, the printer 10 performs prescan, in which images are read at low resolution using the scanner 16 in order to determine reading conditions concerning fine scan for obtaining output images and determine image processing conditions concerning various kinds of image processing (step S102). During the prescan, the scanner 16 associates the frame numbers and the images with one another and sends them to necessary sites such as the back print information edit-and-output part 50, the adjustment part 22, and the image processing part 28. In addition, in the case of an APS film, during the prescan, the scanner 16 reads a magnetic recording medium and sends necessary information, such as photographing information showing film IDs, whether an electronic flash was used at-the time of photographing and the like, and information on a camera model (type of film-with-lens), to necessary sites such as the back print information edit-and-output part 50, the adjustment part 22, and the image processing part 28.

On the other hand, in the case of print creation from images (image data) photographed with a digital camera or the like (hereinafter referred to as the “print creation from image data”), the DIC 20 captures the image data (step S103) and generates inspection images by performing thinning-out or the like (step S104). Also, the DIC 20 sends various kinds of information obtained from the image data (image files), such as frame numbers (file numbers and/or folder numbers), a camera model, photographing information as to whether an electronic flash was used at the time of photographing and the like, to necessary sites such as the back print information edit-and-output part 50, the adjustment part 22, and the image processing part 28.

Next, the image processing unit 18 or the DIC 20 displays inspection images, and inspection is conducted (step S105). Note that the inspection is carried out in basically the same manner as in the case of a known digital photoprinter. Accordingly, in the case of print creation from a film, inspection images are created using images (prescan data) obtained through prescan. Also, like in the case of a known digital photoprinter, image processing conditions concerning image processing to be described later are set with reference to prescan data or thinned-out images for generation of inspection images, and image processing corresponding to the image processing conditions is performed on inspection images.

It should be noted that in the printer 10 according to the present invention, the inspection is not an indispensable process. Also, an ordinary mode in which the inspection is performed, and an automatic mode in which the inspection is not performed, may be set as operation modes and one of the modes may be selected.

When the colors, densities, or the like of images have been adjusted through the inspection, the color/density correction conditions concerning image processing to be described later and the like are also adjusted accordingly.

In addition, when the colors or densities of the images have been adjusted through the inspection, information (information as to the adjustment) showing adjustment amounts in respective colors (C (cyan), M (magenta), and Y (yellow) in ordinary cases) and information showing adjustment amounts of the densities are sent to the back print information edit-and-output part 50.

In the illustrated embodiment, the inspection is performed every unit of six frames in which images in six frames are displayed at a time.

In the case of print creation from a film, when inspection OK has been inputted for all the images in six frames displayed at a time, fine scan for obtaining print images (output image data) is performed for each frame in succession (step S106) and image processing is performed on each image in a frame (fine scan data) in succession (step S107).

Also, in the case of print creation from image data, when inspection OK has been inputted, image processing is performed on each image in a frame in succession, thereby obtaining print images (step S108).

Here, the image processing of step S107 and the image processing of step S108 will be described.

As described above, the image processing performed by the image processing unit 18 in step S107 and the image processing performed by the DIC 20 in step S108 are basically the same.

In the illustrated embodiment, fundamental image processing through which images are completed in terms of image quality, such as electronic scaling processing (enlargement/reduction of the images), gradation correction, color/density correction, color saturation correction, sharpness processing (sharpening processing), graininess suppression processing, and dodging processing (addition of dodging effects through compression/expansion of image density dynamic ranges in which halftones of the images are maintained), is performed on every image as indispensable image processing (image processing 3 to be described later).

Also, as high-grade image processing performed as necessary in order to correct image defects, red eye correction (correction of red eyes ascribable to photographing using an electronic flash), scratch removal processing (correction of defective pixels (image defective portions) due to scratches in a film or a photographing lens, dusts adhering thereto, or the like)), deteriorated marginal luminosity correction (correction of density unevenness due to deteriorated marginal luminosity of the photographing lens), and aberration correction (correction of distortion due to aberration of the photographing lens) are executed (image processing 1, 2, and 4 to be described later).

Further, when a request has been received from a customer (print creation orderer), special finish processing, such as trimming, soft-focus processing, or cross-filter processing, which corresponds to the request from the customer is performed as image processing 5 to be described later.

It is sufficient that each image processing described above is carried out with a known method. Also, the sharpness processing and the graininess suppression processing may be performed at the same time (graininess suppression sharpness processing).

For instance, the red eye correction is carried out with a method with which each red eye candidate (region that is likely to be a red eye) is first detected from an image, face detection is performed in a predetermined region on the periphery of the red eye candidate, the red eye candidate around which a face is detected is identified as a red eye, and the red eye is corrected through correction of the color, color saturation, and the like of the red eye region. With the method, as compared with an ordinary red eye correction method with which face detection is first performed and then red eye detection is performed in each face, the number of times of the face detection that takes a long time is significantly reduced and it becomes possible to perform the red eye correction swiftly. Note that it is sufficient that the red eye candidate detection is performed with a method with which each circular region having a red hue and having at least a predetermined number of pixels is detected as a red eye candidate using red eye color information and shape information. Also, it is sufficient that the face detection is performed with a known method such as a method based on template matching that uses a face template created from many face image samples in advance or a face detection method based on a learning technique with which preliminary learning, in which characteristic amount extraction is performed with respect to many face images and non-face images and a function or a threshold value for separating faces and non-faces from each other is calculated based on a result of the characteristic amount extraction, is performed, and face detection is performed by extracting characteristic amounts from a target image in the same manner as in the preliminary learning and performing discrimination between faces and non-faces using the function or the threshold value obtained through the preliminary learning.

Also, it is sufficient that the scratch removal processing is performed with a method disclosed in JP 2000-74846 A with which line segments satisfying a condition are detected through edge detection, each defective portion ascribable to a dust or a scratch is detected using the line segments, and the defective portion is corrected through complementation using continuity with peripheral pixels or image data of peripheral regions or the like, a method disclosed in JP 2000-92319 A with which each defect candidate region ascribable to a dust or a scratch is detected with reference to the magnitude of a difference between a smoothed image and an original image, each defective portion is detected with reference to characteristics of the candidate region such as changes in shape and color, and the defective portion is corrected in the same manner as above, or the like.

In addition, when prints are created from a film, it is also possible to suitably use a method with which image reading with IR light (infrared light) is performed in addition to ordinary image reading in R (red), G (green), and B (blue), the position of each dust or scratch on the film is detected using a result of the reading with the IR light in which the IR light is shielded or scattered by the dust or scratch on the film, and each defective portion is corrected in the same manner as above.

Further, it is sufficient that the lens aberration correction and the deteriorated marginal luminosity correction (hereinafter referred to as the “lens correction”) are performed with a method disclosed in JP 11-225270 A with which the lens characteristics of cameras are acquired and stored in advance, the type (lens type) of a camera used to photograph images is detected, and the lens aberration correction and/or the deteriorated marginal luminosity correction are/is performed using lens characteristics corresponding to the detected camera type, for instance.

It should be noted that in the case of print creation from an APS film, for instance, it is sufficient that the camera model is detected by also reading magnetic information at the time of reading with a scanner and analyzing the information. On the other hand, in the case of print creation from image data, it is sufficient that the camera model is detected by analyzing various kinds of information recorded in image files.

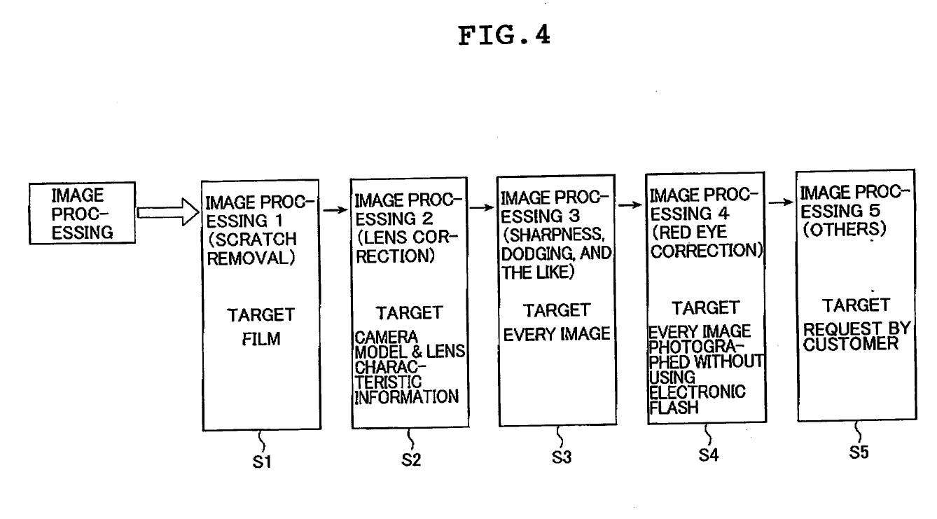

In the printer 10 in the illustrated embodiment, as schematically shown in FIG. 4, the image processing is executed in the order of the scratch removal processing (image processing 1: step S1), the lens correction (image processing 2: step S2), the fundamental image processing (image processing 3: step S3), the red eye correction (image processing 4: step S4), and special processing requested by a customer (image processing 5: step S5).

Here, in the illustrated embodiment, the scratch removal processing is executed only in the case of print creation from a film. Also, the lens correction is executed only when it is possible to identify the model of a camera used to photograph images and is executed only on images photographed by the camera model having lens characteristics. Further, the image processing 3 that is the fundamental processing is carried out on every image, as described above. Still further, the red eye correction is executed on every image except for images that have been confirmed as not photographed using an electronic flash with reference to photographing information or the like. The special processing is executed only on images requested by the customer.

It should be noted that the present invention is not limited to this and another construction may be used instead in which each image processing other than the image processing 3 that is the fundamental processing is selectable/settable as to whether the image processing is to be executed. Alternatively, a construction may be used in which among the image processing 3, the sharpness processing and/or the dodging processing carried out in order to achieve higher image quality are/is selectable/settable as to whether the processing is to be executed.

Still alternatively, various modes, such as an ordinary mode corresponding to creation of ordinary prints and a premium mode corresponding to creation of prints (premium prints) that are expensive but have high quality as compared with the ordinary prints, may be set, and image processing to be executed in each mode may be selected/set in advance. For instance, a setting may be made so that every image processing is to be executed in the premium mode and only the image processing 3 is to be carried out in the ordinary mode, and a setting may be made by selecting a mode at the time of setting film, capturing image data, or an inspection. Also, multiple premium modes may be prepared as premium mode 1, premium mode 2, . . . . More specifically, for instance, premium mode 1 may be prepared which corresponds to creation of prints from images photographed with a film-with-lens, an inexpensive camera, a mobile telephone, or the like and in which every image processing is to be performed, premium mode 2 may be prepared which corresponds to creation of prints from images photographed on a film with an ordinary camera and in which only the scratch removal, the image processing 3, and the red eye correction are to be carried out, and premium mode 3 may be prepared which corresponds to creation of prints from images photographed with an ordinary digital camera and in which only the image processing 3 and the red eye correction are to be executed. In this case, different charging systems may be set for the respective premium modes.

When it is selected as to whether or not each image processing is to be executed, or whether or not every image processing corresponding to the high-grade processing is executed, the adjustment part 22 or the image processing part 28 is set to also function as a selection part, for instance. In this case, it is sufficient that the adjustment part 22 or the image processing part 28 selects which image processing is to be executed in accordance with order information acquired together with image data or instructions inputted from the instruction input device 26. Alternatively, a selection part may be provided separately from the image processing part 28.

Here, needless to say, selection or setting for execution of the image processing 5 that is special processing corresponding to a customer's request is not performed, and the execution/non-execution of the processing is set only in accordance with the customer's request.

Also, information as to each image processing executed at the image processing unit 18 or the DIC 20 is supplied to the back print information edit-and-output part 50.

For instance, as information as to the scratch removal processing (image processing 1), information showing whether the processing has been executed and the number of corrections made is supplied to the back print information edit-and-output part 50. Also, as information as to the lens correction (image processing 2), information showing whether the aberration correction and/or the deteriorated marginal luminosity correction have/has been executed is supplied to the back print information edit-and-output part 50. Further, as information as to the image processing 3, information showing whether the sharpness processing and the dodging processing have been executed is supplied to the back print information edit-and-output part 50. Still further, as information as to the red eye correction (image processing 4), information showing whether the processing has been executed and the number of corrections made is supplied to the back print information edit-and-output part 50. Also, as information as to the image processing 5, information as to each image processing executed is supplied to the back print information edit-and-output part 50.

It should be noted that the information as to the image processing supplied to the back print information edit-and-output part 50 (that is, recording contents of back prints) is not limited to this information and various other kinds of information are usable. Also, it is preferable that the information as to the image processing be information corresponding to each image processing as will be described below, that is, it is preferable that the information as to the image processing to be back-printed differ depending upon image processing.

Basically, it is preferable that the information as to the image processing to be back-printed (recording contents of back prints) be increased if the back printing thereof is possible. Also, it may be such that the information to be recorded as back prints is selected.

For instance, as the information as to the scratch removal processing, in addition to the information showing whether the processing has been executed and the number of corrections made, it is possible to use information showing the number of defective portions detected, the positions (coordinates) of the defective portions and/or correction portions, a correction degree (strength), and the like.

As the information as to the lens correction, in addition to the information showing whether each image processing has been executed, it is possible to use information showing the strength of the aberration correction and other information as to the aberration correction and it is possible to use information showing the strength of the deteriorated marginal luminosity correction and other information as to the deteriorated marginal luminosity correction.

Further, as the information as to the sharpness processing, in addition to the information showing whether the processing has been executed, it is possible to use information showing the strength of the sharpening and other information as to the sharpness processing. Still further, as the information as to the dodging processing, in addition to the information showing whether the processing has been executed, it is possible to use information showing the strength of the dodging and other information as to the dodging processing. Note that it is preferable that in addition to the information described above, the information as to the image processing 3 include information showing a graininess suppression degree (strength) as information as to the graininess suppression processing.

As the information as to the red eye correction, in addition to the information showing whether the correction has been conducted and the number of corrections made, it is possible to use information showing the number of red eyes detected, the positions (coordinates) of the red eyes and/or correction portions, and a red eye correction degree (strength) and other information.

When trimming has been performed, in addition to information showing whether the trimming has been performed, information showing a trimming position, whether center trimming or free trimming has been performed, and other information is used.

Also, when soft-focus processing has been performed, in addition to information showing whether the soft-focus processing has been performed, information showing the set strength of the processing and the other information is used.

Further, when cross-filter processing has been performed, in addition to information showing whether the cross-filter processing has been performed, information showing the number of cross-filters, the positions (coordinates) of the cross-filters, the brightness of the cross-filters, and other information is used.

Print images (image data for print output) having undergone the image processing are supplied from the input apparatus 12 to the output apparatus 14 (step S109).

Here, back print information for recording back prints generated by the back print information edit-and-output part 50 is associated with each print image and is outputted to the control system 38 of the output apparatus 14 together with the print image.

As described above, to the back print information edit-and-output part 50, information as to the image color/density adjustment made at the time of the inspection and information as to the image processing are supplied.

The back print information edit-and-output part 50 generates information of back prints pursuant to a photographic print standard as first back print information (back print 1) using information such as the information as to the color/density adjustment in the inspection and information showing the frame numbers of the images (step S110). Note that the processing of step S110 may be performed in parallel with the processing of steps S106 to S109 without waiting for the processing of steps S106 to S109 to be completed.

In addition, the back print information edit-and-output part 50 generates information of back prints showing execution states of the image processing as second back print information (back print 2) using the information as to the image processing (step S111).

As described above, in the illustrated embodiment, as the information as to the lens correction, the sharpness processing, the dodging processing, and the special processing, the information showing whether the processing has been executed is supplied to the back print information edit-and-output part 50 as the image processing information. With reference to the supplied information, the back print information edit-and-output part 50 generates, second back print information showing that the image processing has been executed for each image processing executed, and does not generate such second back print information for each image processing not executed. Alternatively, for the image processing not executed, the back print information edit-and-output part 50 may generate second back print information showing that the image processing has not been executed.

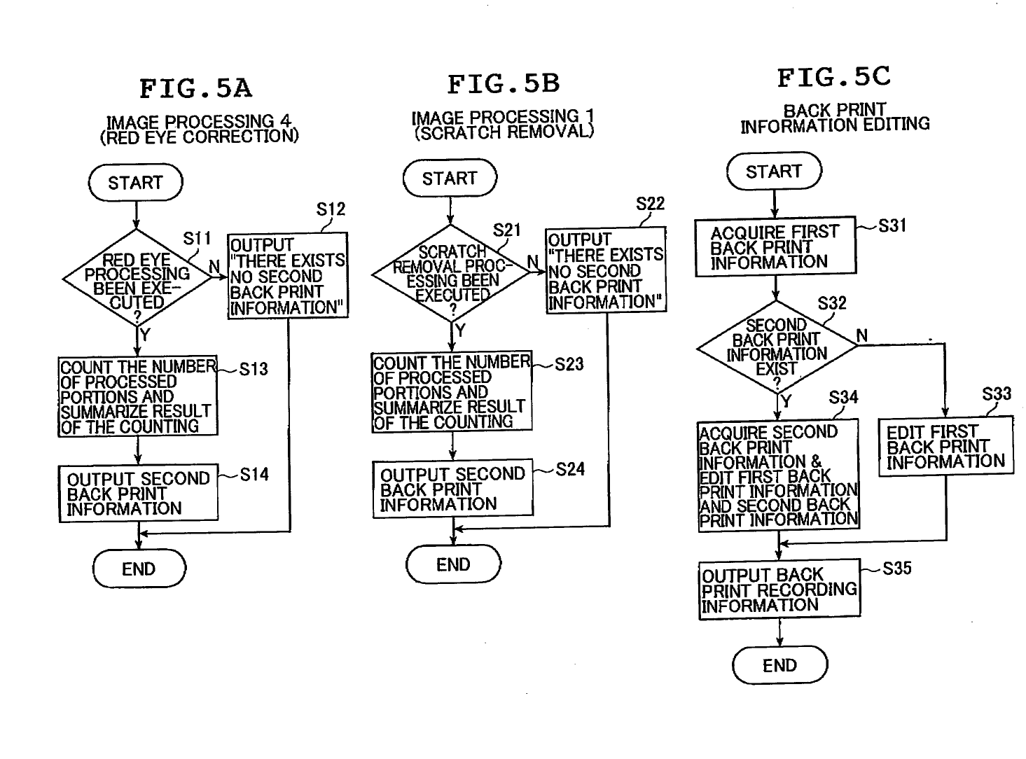

On the other hand, as to the red eye correction and the scratch removal processing, in addition to the information showing whether the processing has been executed, the information showing the number of corrections made is also supplied to the back print information edit-and-output part 50, so the back print information edit-and-output part 50 generates second back print information as shown in flowchart of the red eye correction shown in FIG. 5A and a flowchart of the scratch removal processing shown in FIG. 5B. That is, first, it is judged whether the processing (red eye correction and scratch removal processing) has been executed (step S11 or S21). Following this, when the processing has not been executed (N), second back print information as to the red eye correction and scratch removal processing is not generated (step S12 or S22). Alternatively, like in the case of the lens correction, the sharpness processing, the dodging processing, and the special processing, second back print information showing that the processing has not been executed may be generated.

When the processing has been executed (Y), the number of processed portions is counted and a result of the counting is compiled (step S13 or S23). Then, information showing that the processing has been executed and information showing the number of processed portions are outputted as second back print information (step S14 or S24). Note that when the red eye correction or scratch removal processing has been carried out and no red eye or defective portion has been detected as a result of image analysis, second back print information is generated which shows that the processing has been executed and gives “0” as the number of corrections made.

Next, the back print information edit-and-output part 50 edits the first back print information and the second back print information, associates the edited information with corresponding print images as information for recording back prints (hereinafter referred to as the “back print recording information”), and outputs them to the control system 38 of the output apparatus 14 (step S112).

In the back print information edit processing, as shown in FIG. 5C, the back print information edit-and-output part 50 first acquires the first back print information (step S31) and next judges whether the second back print information exists (step S32). Following this, when a result of the judgment is negative (N), the back print information edit-and-output part 50 edits only the first back print information (step S33), generates back print recording information so that back printing pursuant to a photographic print standard is performed, and outputs the back print recording information to the output apparatus 14 (step S35).

On the other hand, when the judgment result is affirmative (Y), the back print information edit-and-output part 50 acquires the second back print information, edits the first back print information and the second back print information (step S34), generates back print recording information so that back printing pursuant to a photographic print standard is performed with reference to the first back print information and predetermined back printing corresponding to image processing executed is performed with reference to the second back print information, and outputs the back print recording information to the output apparatus 14 (step S35).

It should be noted here that the back printing in accordance with the second back print information is not specifically limited and it is sufficient that a format, in which it is possible to have the customer know each image processing executed or the image processing executed as well as the number of processed portions, is determined as appropriate.

For instance, when the scratch removal processing has been executed, a back print “scratch[o] num[x] (“o” indicates that the processing has been executed and a variable to which the number of processed portions is assigned)” is recorded. Also, when the deteriorated marginal luminosity correction has been executed, a back print “dma[o]” is recorded. Further, when the aberration correction has been executed, a back print “distortion[o]” is recorded. Still further, when the sharpness processing has been executed, a back print “sharp[o]” is recorded. Also, when the dodging processing has been executed, a back print “tone[o]” is recorded. Also, when the red eye processing has been executed, a back print “redeye[o] num[x]” is recorded. Here, it is sufficient that the back prints are recorded in a row or in two rows.

It should be noted here that in the illustrated embodiment, no second back print information is generated for image processing not executed, so back printing is not performed for the corresponding image processing. Alternatively, for the image processing not executed, a symbol, such as [-], may be recorded to follow letters representing the image processing.

It should be noted here that when possible in terms of the ability of the back printer 34 of the output apparatus 14, the back prints based on the second back print information may be recorded in a language in a region in which the printer 10 is used. In this case, when the printer is used in Japan, for instance, the back prints are recorded in Japanese. Also, the back prints corresponding to the first back print information may be recorded using symbols or ciphers that are understandable only by experts like in the case of conventional photoprinters, however, it is preferable that the back prints corresponding to the second back print information be recorded so that the contents of the back prints are understandable also by customers requested print creation. Further, as necessary, explanation of the back prints corresponding to the second back print information may be additionally recorded as a back print. Still further, a construction may be used in which it is possible to make a setting in which only the back prints corresponding to the second back print information are recorded.

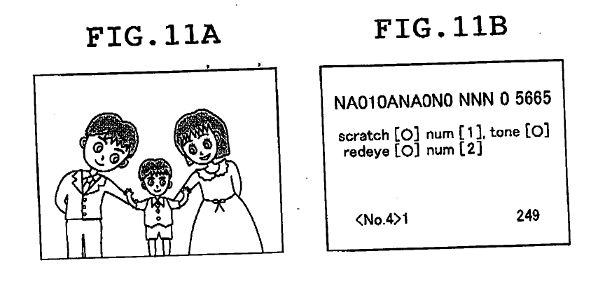

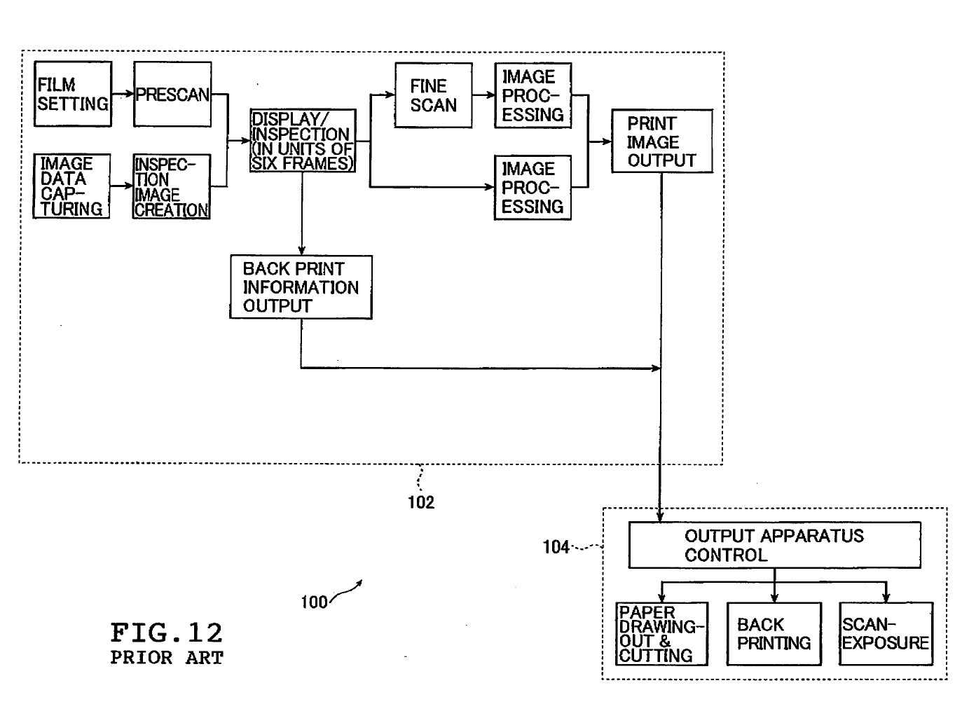

The back prints may be recorded using characters (1 byte, 2 byte) like in an example shown in FIG. 11B or may be recorded using marks (symbols) set as appropriate. In addition, the back prints may be recorded in monochrome or in color.

Also, the color, size, font, and the like of the back prints corresponding to the first back print information and those of the back prints corresponding to the second back print information may be set different from each other. Further, when the back prints are recorded in two rows or in three or more rows, the back prints corresponding to the first back print information may be recorded in certain rows and the back prints corresponding to the second back print information may be recorded in the remaining rows.

Still further, in the case of images photographed with a digital camera or the like, photographing information, file names, and the like obtained from image files may be additionally back-printed. In this case, the photographing information, file names, or the like is recorded together with information as to image adjustment corresponding to the first back print information, for instance.

As described above, the print images and the back print recording information based on the first and second back print information corresponding to the print images are associated with each other and are outputted to the output apparatus 14.

Here, in addition to the outputting to the output apparatus 14, the input apparatus 12 may record the print images and the information of the back prints based on the second back print information on a storage medium and/or may output the print images and the back print information to an external apparatus through a communication network or the like.

At the output apparatus 14, the operation of each part is controlled based on the inputted print images and back print recording information (step S113). Under the control, at the output apparatus 14, first, the photosensitive material A is drawn out from the magazine 30 and is cut by the cutter 32 in accordance with a print size (step S114).

Next, while conveying the photosensitive material A toward a predetermined exposure position through a predetermined conveying path, back prints are recorded (back printing is performed) on a surface (back surface) on a side opposite to an image recording surface by the back printer 34 in accordance with the back print recording information corresponding to the print images to be reproduced on the photosensitive material A (step S115). Note that the back prints include not only prints based on the first back print information and pursuant to a photographic print standard but also prints corresponding to the second back print information and concerning the image processing carried out on the print images.

Then, while conveying the photosensitive material A having undergone the back printing at an exposure position in an auxiliary scanning direction, scan-exposure is two-dimensionally performed by the exposure unit 36 with the light beam L modulated in accordance with the print images (images corresponding to the recorded back prints, as described above) and deflected in a main scanning direction, thereby recording latent images on the image recording surface of the photosensitive material A (step S116).

The photosensitive material A, on which the latent images have been recorded, is supplied to the development unit 40, at which the photosensitive material A is subjected to development processing in which development, bleaching/fixation, and rinsing are performed in succession, the developed photosensitive material is dried and is outputted as finished (photographic) prints, and the prints are sorted in units of orders.

The prints according to the present invention obtained in the manner described above have front surfaces, that is, image recording surfaces, on which images have been recorded as shown in FIG. 11A, and have back surfaces on which information corresponding to image processing performed to obtain the images has been printed as shown in FIG. 11B. In the example shown in FIG. 11B, as a preferable example, the back print corresponding to the first back print information has been recorded in the first row and the back print corresponding to the second back print information has been recorded in the second and third tows. In addition, a frame number and the like are printed in a row below the above back prints.

As is apparent from the above explanation, according to the present invention, when high-grade processing, such as red eye correction, dust/scratch removal, lens aberration correction, and deteriorated marginal luminosity correction, has been performed in outputting the prints, information as to the high-grade processing is recorded as a back print, so it becomes possible to have a customer who requested print creation or the like notice that the high-grade processing has been executed at much expense in time and effort and recognize the effect of the high-grade processing with reliability. Accordingly, according to the present invention, it becomes possible to achieve high-value-added prints or the like, differentiation from images for which no high-grade processing has been performed, differentiation from other stores such as laboratory stores, price maintenance with respect to other stores, acquiring and ensuring of customers, and the like.

In addition, when reprinting is performed in accordance with a request to correct red eyes or the like, it becomes possible for an operator at a laboratory store or the like to know the image processing performed at the time of previous print outputting from the back prints, so it becomes possible to solve problems by performing image processing as appropriate and output requested reprints with reliability.

Next, a second embodiment of the printer according to the present invention will be described.

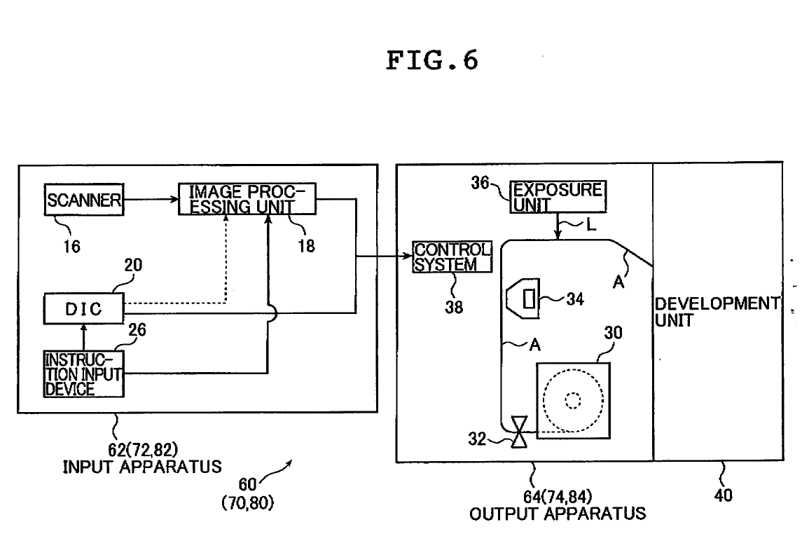

FIG. 6 shows a schematic construction of the printer of the second embodiment according to the present invention.

A printer 60 shown in FIG. 6 is a photoprinter that is the same as the printer 10 described above (see FIG. 1) and includes an input apparatus 62 and an output apparatus 64. The input apparatus 62 and the output apparatus 64 have constructions that are similar to the constructions of the input apparatus 12 and the output apparatus 14 of the printer 10 described above, respectively. In the following description, each construction element that is the same as a construction element of the printer 10 described above is given the same reference numeral and the detailed description thereof will be omitted. Therefore, characteristic portions of the printer in the second embodiment will be mainly explained below.

In an illustrated embodiment, the input apparatus 62 includes the scanner 16, the image processing unit 18, the DIC 20, and the instruction input device 26. Note that the input apparatus 62 may have a construction including only one of the scanner 16 and the DIC 20 or may have a construction including the DIC 20 and the instruction input device 26 but not including the scanner 16 and the image processing unit 18.

Also, in the embodiment shown in FIG. 6, only one instruction input device 26 that is common to the image processing unit 18 and the DIC 20 is illustrated, however, one instruction input device 26 may be provided for each of the image processing unit 18 and the DIC 20 like in the embodiment shown in FIGS. 1 and 2 described above.

In this embodiment, the instruction input device 26 is an instruction input device such as a combination of a keyboard and a mouse, which is used to input designation of the size of prints to be outputted and the number of the prints, designation of image processing, instructions as to inspection, and the like. Information inputted with the instruction input device 26 is supplied to the image processing unit 18 when the inputted information is instruction information as to image data acquired by the scanner 16 and is supplied to the DIC 20 when the inputted information is instruction information as to image data acquired by the DIC 20.

Like in the embodiment shown in FIG. 2, in this embodiment, each of the image processing unit 18 and the DIC 20 includes an image processing function (image processing part 28) and a display/inspection function (display device 24, adjustment part 22, and instruction input device 26).

Also, like in the embodiment described above, a back print information edit-and-output part is arranged in at least one of the image processing unit 18 and the DIC 20. In this embodiment, like in the first embodiment described above, a form, in which the image processing unit 18 and the DIC 20 each include the back print information edit-and-output part, will be described as an example.

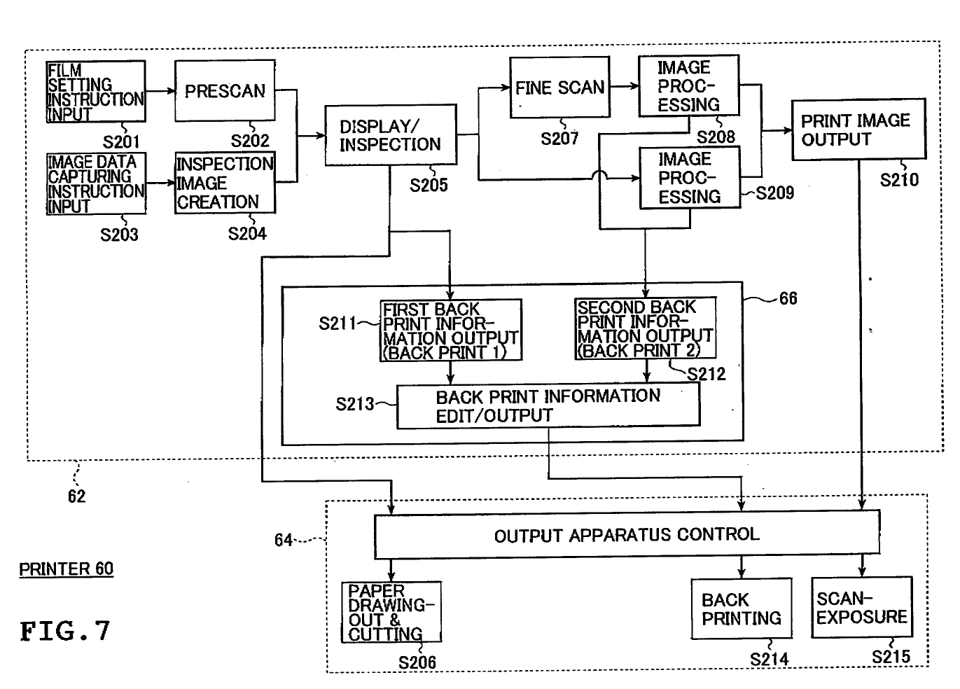

A back print information edit-and-output part 66 in this embodiment will be described in detail below with reference to FIG. 7, however, it has basically the same function as the back print information edit-and-output part 50 in the printer 10 described above.

Hereinafter, the back print information edit-and-output part 66 and the present invention will be described in more detail by explaining an action of the printer 60 with reference to FIG. 7.

FIG. 7 shows a flow of print creation processing in the printer 60. In FIG. 7, processing at the input apparatus 62 is illustrated in a space surrounded by a broken line given reference numeral 62 and processing at the output apparatus 64 is illustrated in a space surrounded by a broken line given reference numeral 64. Also, among the processing at the input apparatus 62, processing at the back print information edit-and-output part 66 is illustrated in a space surrounded by a solid line given reference numeral 66. Further, processing at the scanner 16, processing at the image processing unit 18, and processing at the DIC 20 are collectively illustrated as the processing at the input apparatus 62.

In the case of print creation from a film, the film is set at a predetermined position (film carrier) of the scanner 16 and it is instructed to start scanning (step S201). In response to the instruction, the printer 60 (input apparatus 62) performs prescan, in which images are read at low resolution, using the scanner 16 in order to determine reading conditions concerning fine scan for obtaining output images and determine image processing conditions concerning various kinds of image processing (step S202). Also, during the prescan, the printer 60 generates information, in which frame numbers and images are associated with one another, and sends the information to sites, such as the back print information edit-and-output part 66, the adjustment part 22, and the image processing part 28 (see FIG. 2), at which the information is used. In the case of an APS film, during the prescan, the printer 60 further reads a magnetic recording medium and sends information necessary for print creation processing, such as photographing information showing film IDs, whether an electronic flash was used at the time of photographing, a zoom magnification and the like, and camera information showing a camera model (type of film-with-lens), a lens type and the like, to sites, such as the back print information edit-and-output part 66, the adjustment part 22, and the image processing part 28, at which the information is used. The photographing information, the camera information, and the like may be inputted through operator's manipulations of the instruction input device 26.

On the other hand, in the case of print creation from images (image data) photographed with a digital camera or the like (hereinafter referred to as the “print creation from image data”), the DIC 20 captures the image data (step S203) and generates inspection images by performing thinning-out or the like (step S204). Also, the DIC 20 sends various kinds of information, such as frame numbers (file numbers and/or folder numbers), camera information showing a camera model, photographing information as to whether an electronic flash was used at the time of photographing, a zoom magnification and the like, obtained from the image data (image files) to necessary sites such as the back print information edit-and-output part 50, the adjustment part 22, and the image processing part 28.

In addition, at the time of reception of a print order, at the time of setting film to the scanner 16, at the time of capturing image data by the DIC 20, at the time of inspection to be described later, or the like, information (print information) concerning a print order that shows print frame numbers, a print size, the number of prints, designation of image processing, and the like is inputted through the instruction input device 26 (steps S201, S203). The inputted information is sent to sites, such as the back print information edit-and-output part 66, the adjustment part 22, and the image processing part 28, at which the information is used. Alternatively, the input apparatus 62 may acquire the print information described above from information attached to image data. That is, it is possible to have the instruction input device 26, the scanner 16, or the DIC 20 function as a print information acquisition unit.

Next, the image processing unit 18 Or the DIC 20 displays inspection images on an inspection screen of the display device 24 (display) and inspection is conducted on the inspection images (step S205). Note that the inspection is the same as that in the embodiment described above and is conducted in basically the same manner as in the case of known digital photoprinters.

It should be noted here that like in the printer 10 described above, in the printer 60 in this embodiment, the inspection is not an indispensable process. Also, an ordinary mode in which the inspection is performed, and an automatic mode in which the inspection is not performed, may be set as operation modes and one of the modes may be selected.

When instructions have been inputted through the inspection, and the colors, densities, and/or the like of images have been adjusted, the color/density correction conditions concerning image processing to be described later and the like are also adjusted accordingly.

Also, when inspection OK (output instruction) has been inputted with predetermined determination means (determination part) such as an “OK” key of a keyboard (instruction input device 26), images are determined. In response to this, information showing the print size of each image in a frame and the number of prints of the image inputted with the instruction input device 26 is also determined and the information showing the print size and the number of prints is sent to the output apparatus 64 (indicated by the arrow from step S205 to output control of the output apparatus 64).

In addition, when the colors and densities of the images have been adjusted through the inspection, information (information as to the adjustment) showing adjustment amounts in respective colors (C (cyan), M (magenta), and Y (yellow) in ordinary cases) and adjustment amounts of the densities are sent to the back print information edit-and-output part 66.

It should be noted here that when the inspection is not performed, images are determined when image processing conditions have been set (image automatic determination through image processing condition setting). Therefore, the information showing the print size of each image in a frame and the number of prints of the image inputted with the instruction input device 26 is also determined and the information showing the print size and the number of prints is sent to the output apparatus 64. In this case, the adjustment part 22 or the image processing part 28 also functions as a determination part.

In this embodiment, when images for obtaining prints have been determined through input of inspection OK, information showing the print size of each image in a frame and the number of prints of the image is also determined and the information showing the print size and the number of prints is sent to the output apparatus 64 (control system 38). When the information has been received, the output apparatus 64 starts to draw out and cut a print sheet (paper) (step S206), thereby coping with both acceleration of the image processing and acceleration of the first print. This point will be described in detail later.

In the printer 60, images in six frames are displayed at a time on the inspection screen and the inspection is performed in units of six frames.

In the case of print creation from a film, when inspection OK has been inputted for all of images in six frames displayed at a time, fine scan for obtaining print images (output image data) is performed for each frame in succession (step S207) and image processing is performed on each image in a frame (fine scan data) in succession (step S208).

In the case of print creation from image data, when inspection OK has been inputted, image processing is performed on each image in a frame in succession (step S209), thereby obtaining print images (step S210).

The image processing by the image processing unit 18 of step S208 and the image processing by the DIC 20 of step S209 are respectively the same as the image processing of step S107 and the image processing of step S108 in the first embodiment described above (see FIG. 3). Therefore, the concrete contents of the image processing will not be described in this embodiment.

Information as to each image processing executed at the image processing unit 18 and the DIC 20 is supplied to the back print information edit-and-output part 66.

As the information as to each image processing supplied to the back print information edit-and-output part 66, it is possible to cite the same information as that in the first embodiment described above. That is, for instance, in accordance with image processing executed, information showing execution/non-execution of each image processing and the number of corrections made is supplied from the image processing part 28 to the back print information edit-and-output part 66. Other information may be added.

Print images (image data for print output) having undergone the image processing are supplied from the input apparatus 62 to the output apparatus 64 (step S210).

Here, back print information generated by the back print information edit-and-output part 66 is associated with respective print images, and the print images and the information for recording back prints are outputted to the control system 38 of the output apparatus 64.

As described above, to the back print information edit-and-output part 66, information as to the image color/density adjustment made in the inspection and information as to the image processing are supplied.

The back print information edit-and-output part 66 generates information of back prints pursuant to a photographic print standard as first back print information (back print 1) using information such as the information as to the color/density adjustment made in the inspection and information showing the frame numbers of the images (step S211).

In addition, the back print information edit-and-output part 66 generates information of back prints showing the execution states of the image processing as second back print information (back print 2) using the information as to the image processing (step S212).

A method of generating the second back print information used in step S212 is the same as the method used in step S111 (see FIG. 3) in the first embodiment and described using FIGS. 5A and 5B.

Next, the back print information edit-and-output part 66 obtains information (hereinafter referred to as the “back print recording information”) for recording back prints by editing the first back print information and the second back print information, associates the back print recording information with corresponding print images, and outputs them to the control system 38 of the output apparatus 64 (step S213).

The back print information edit processing by the back print information edit-and-output part 66 in step S213 is the same as the processing of step S112 in the first embodiment described using FIG. 5C.

Also, the format of back prints corresponding to the second back print information is the same as that described in the first embodiment.

As described above, the print images and the back print recording information generated from the first and second back print information corresponding to the print images are associated with each other and are outputted to the output apparatus 64.

Also, in addition to the outputting to the output apparatus 64, the input apparatus 62 may record the print images and the information of the back prints based on the second back print information on a storage medium and/or may output the print images and the back print information to an external apparatus through a communication network or the like.

As described above, when images have been determined through input of inspection OK at the input apparatus 62, information showing the print size of each image in a frame and the number of prints of the image is sent to the control system 38 of the output apparatus 64. Under control by the control system 38, when the print size of the first frame and the number of prints of the frame have been acquired, the output apparatus 64 draws out the photosensitive material A from the magazine 30, cuts the drawn-out material A with the cutter 32 in accordance with the print size, and supplies the cut material A (step S206). Following this, the supply of the photosensitive material A is continued subsequently in accordance with the progress of processing in the output apparatus 64 and supplied information showing the print size and the number of prints.

Next, while conveying the photosensitive material A toward a predetermined exposure position through a predetermined conveying path, back prints are recorded (back printing is performed) by the back printer 34 in accordance with the back print recording information corresponding to the print images to be reproduced on the photosensitive material A (step S214). The back prints include not only prints which is based on the first back print information and pursuant to a photographic print standard but also prints which correspond to the second back print information and concern the image processing carried out on the print images. Here, when back print recording information that should be recorded on the supplied photosensitive material A is not yet acquired, the control system 38 places the photosensitive material A in a standby state in front of the back printer 34. Following this, upon acquisition of the back print recording information, the control system 38 conveys the photosensitive material A to the position of the back printer 34, at which back printing is performed.

In addition, while conveying the photosensitive material A having undergone the back printing at the exposure position of the exposure unit 36 in an auxiliary scanning direction, scan-exposure is two-dimensionally performed with the light beam L which was modulated in accordance with the print images (images corresponding to the recorded back prints) and deflected in a main scanning direction, thereby recording latent images (step S215). Here, when image data of images that should be recorded on the supplied photosensitive material A is not yet acquired, the control system 38 places the photosensitive material A in a standby state in front of the exposure unit 36. Following this, upon acquisition of the image data, the control system 38 conveys the photosensitive material A to the exposure position, at which the latent image recording is performed.

The photosensitive material A on which the latent images have been recorded is supplied to the development unit 40, at which the photosensitive material A is subjected to development processing in which development, bleaching/fixation, and rinsing are performed in succession, the developed photosensitive material is dried and is outputted as finished (photographic) prints, and the prints are sorted in units of orders.

As is apparent from the above explanation, according to the present invention, when information necessary to supply print sheets has been acquired by the output apparatus, print sheet supply is started without waiting for the image data of images having been subjected to high-grade processing-and back print recording information for recording back prints to be received by the output apparatus, so even when image data creation takes a long time due to high-grade processing execution, it becomes possible to shorten the first print time.

In addition, according to the present invention, when high-grade processing, such as red eye correction, dust/scratch removal, lens aberration correction, and/or deteriorated marginal luminosity correction, has been performed in outputting of prints, information as to the high-grade processing is recorded as a back print, so it becomes possible to have a customer who requested print creation and/or the like notice that the high-grade processing has been executed at much expense in time and effort and recognize the effect of the high-grade processing with reliability. Thus, according to the present invention, it becomes possible to achieve high-value-added prints and/or the like, differentiation from images for which no high-grade processing has been performed, differentiation from other stores such as laboratory stores, price maintenance with respect to other stores, acquiring and ensuring of customers, and the like. In addition, when reprinting is performed in accordance with a request to correct red eyes or the like, it becomes possible for an operator at a laboratory store or the like to know image processing performed at the time of previous print outputting from the back prints, so it becomes possible to solve problems by performing image processing as appropriate and output requested reprints with reliability.

That is, according to the present invention, it becomes possible to provide mutually opposing effects of outputting high-quality images through high-grade processing and shortening the first print time, and it also becomes possible to have a customer notice the effect of the high-grade processing.

Also, needless to say, according to the present invention, even when high-grade processing is not performed or even when information showing that high-grade processing has been performed and information showing-results of the processing are not back-printed, it becomes possible to shorten the first print time as compared with a conventional case.

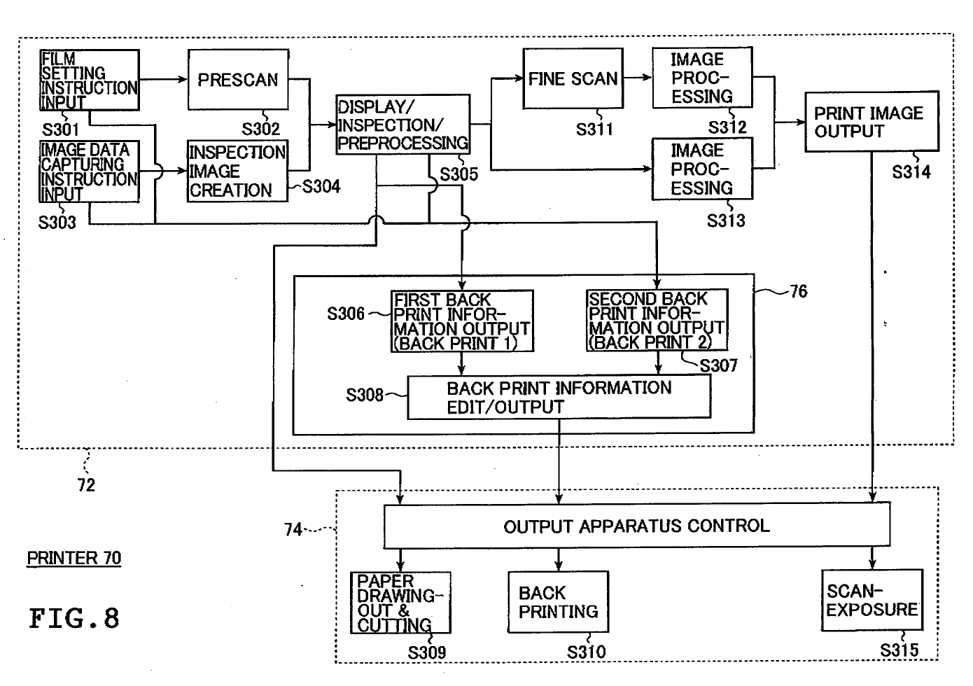

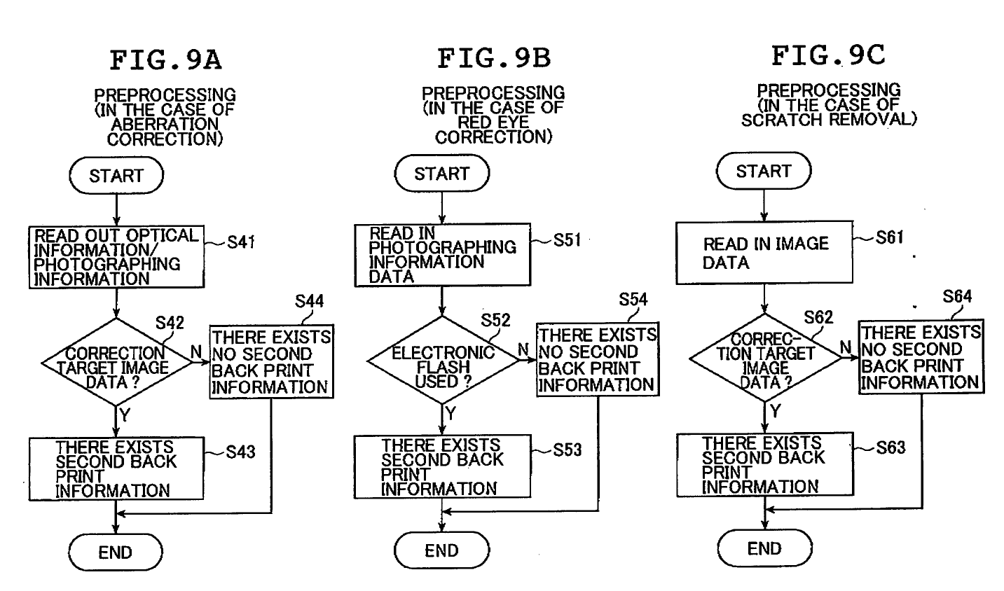

Next, a third embodiment of the present invention will be described. A fundamental apparatus construction of a printer 70 in this embodiment is the same as that of the printer 60 shown in FIG. 6. As shown in FIG. 6, the printer 70 includes an input apparatus 72 and an output apparatus 74. Note that each construction element of the printer 70 that is the same as a construction element of the printer 60 is given the same reference numeral and the following description will be centered on different portions. Also, characteristic portions of this embodiment will be described with reference to FIGS. 8 and 9.

FIG. 8 is an explanatory diagram of an action of the printer 70 of the third embodiment in the present invention.

FIG. 8 shows a flow of print creation processing in the printer 70. In FIG. 8, processing at the input apparatus 72 is illustrated in a space surrounded by a broken line given reference numeral 72 and processing at the output apparatus 74 is illustrated in a space surrounded by a broken line given reference numeral 74. Also, among the processing at the input apparatus 72, processing at a back print information edit-and-output part 76 is illustrated in a space surrounded by a solid line given reference numeral 76. Further, processing at the scanner 16, processing at the image processing unit 18, and processing at the DIC 20 are collectively illustrated as the processing at the input apparatus 72.

In the printer 70, in addition to an image processing function (image processing part 28) and a display/inspection function (display device 24, adjustment part 22, and instruction input device 26), the image processing unit 18 and the DIC 20 (see FIGS. 6 and 2) include a preprocessing part as a selection part that, prior to image processing, selects (chooses/determines) image processing which should be carried out with reference to images (image data), photographing information, camera information and the like that concerns photographed images, and information as to designation of image processing inputted from the instruction input device 26. The adjustment part 22 or the image processing part 28 may be set to also function as the preprocessing part. Alternatively, the preprocessing part may be provided separately from the adjustment part 22 and the image processing part 28. In the following description, a general term “preprocessing part” will be used regardless of which form is adopted.

Also, in the printer 60 in the second embodiment (see FIG. 7), the back print information edit-and-output part 66 generates information of back prints showing the execution states of image processing as second back print information (back print 2) using information as to the image processing. In the printer 70 shown in FIG. 8, however, the back print information edit-and-output part 76 generates information showing that certain image processing has been executed as second back print information (back print 2) using information from the scanner 16, the DIC 20 and the instruction input device 26.

Hereinafter, among the action of the printer 70, a back print information generation method and back print recording will be mainly described with reference to FIG. 8.

At the time of reception of a print order, at the time of setting film to the scanner 16, at the time of capturing image data by the DIC 20, at the time of inspection to be described later, or the like, information (print information) concerning a print order that shows print frame numbers, a print size, the number of prints, designation of image processing, and the like is inputted through the instruction input device 26. The inputted information is sent to sites, such as the back print information edit-and-output part 76, the adjustment part 22, and the image processing part 28 (see FIG. 2), at which the information is used.

In the case of print creation from a film, prescan of the film is performed by the scanner 16 in the same manner as in the second embodiment described above (steps S301 and S302). Also, in the case of an APS film, during the prescan, a magnetic recording portion is read, and information recorded in the magnetic recording portion, such as photographing information showing a film ID, whether an electronic flash was used at the time of photographing, a zoom magnification and the like, and camera information showing a camera model (type of film-with-lens), a lens type and the like, is acquired. The information read from the magnetic recording portion is sent to sites, such as the back print information edit-and-output part 76, the adjustment part 22, the image processing part 28, and the preprocessing part (when the preprocessing part is provided separately), at which the information is used. The photographing information and the camera information may be inputted through operator's manipulations of the instruction input device 26.

In the case of print creation from image data of images photographed with a digital camera or the like, in the same manner as in the second embodiment described above, the DIC 20 captures the image data (step S303) and generates inspection images (step S304). Also, the DIC 20 sends various kinds of information, such as frame numbers (file numbers or file numbers as well as folder numbers), camera information showing a camera model, and photographing information showing whether an electronic flash was used at the time of photographing, a zoom magnification and the like, obtained from the image data (image files) to sites, such as the back print information edit-and-output part 76, the adjustment part 22, and the image processing part 28, at which the information is used.

Next, the image processing unit 18 or the DIC 20 displays the inspection images on an inspection screen of the display device (display) and an operator conducts inspection on the inspection images (step S305) Note that like in the case of the printers 10 and 60 in the first and second embodiments described above, the inspection is not an indispensable process. Also, an ordinary mode in which the inspection is performed, and an automatic mode in which the inspection is not performed, may be set as operation modes and one of the modes may be selected.

When the colors, densities, and the like of the images have been adjusted through the inspection, color/density correction conditions and the like concerning image processing to be described later are also adjusted accordingly. Also, information showing adjustment amounts in respective adjusted colors (C (cyan), M (magenta), and Y (yellow) in ordinary cases) and adjustment amounts of the densities is sent to the back print information edit-and-output part 76.

The back print information edit-and-output part 76 generates information of back prints pursuant to a photographic print standard as first back print information (back print 1) using information such as information as to the color/density adjustment in the inspection and information showing the frame numbers of images (step S306).

The preprocessing part of the image processing unit 18 or the DIC 20 selects image processing that should be carried out on the images based on information concerning photographed images (such as the images (image data), photographing information, and camera information), information showing designation of image processing inputted through the instruction input device 26, and the like obtained from the scanner 16, the DIC 20, and the instruction input device 26 (step S305). Information showing the selected image processing is sent to the image processing part 28, and is also sent to the back print information edit-and-output part 76. The back print information edit-and-output part 76 generates second back print information (back print 2) from the information (step S307).

FIGS. 9A, 9B, and 9C are each a flowchart showing a method of generating the second back print information at the preprocessing part and the back print information edit-and-output part 76. FIG. 9A relates to a case where aberration correction processing has been selected in the preprocessing process, FIG. 9A relates to a case where red eye correction processing has been selected in the preprocessing process, and FIG. 9C relates to a case where scratch removal processing has been selected in the preprocessing process.

In the case of the aberration correction processing, as shown in FIG. 9A, optical information, photographing information, and the like captured in the manner described above are read in (step S41) and it is judged whether image data is correction target image data or not based on zoom information and information (camera information) showing a camera model and a lens type obtained from the read-in information (step S42). When the image data is correction target image data (Y), this means that it has been found from the cameral model information and the lens type information that, for instance, the images were photographed with a film-with-lens or a compact camera, or were zoomed in and photographed, so it is judged that “there exists back print 2 information”. Thus, lens aberration correction and deteriorated marginal luminosity correction are selected, and information showing that the lens aberration correction and the deteriorated marginal luminosity correction are executed is set as the second back print information (step S43). On the other hand, when the image data is not correction target image data (N), this means that it has been found from the photographing information that, for instance, the images were photographed with a single-lens reflex camera or in particular a camera equipped with a specific high-performance lens, so the lens aberration correction and the deteriorated marginal luminosity correction are not selected and it is judged that “there exists no back print 2 information” (step S44).

In the case of the red eye correction processing, as shown in FIG. 9B, the photographing information is read in (step S51) and it is judged from the information whether the currently processed images are images photographed using an electronic flash or not (step S52). When the images were photographed using an electronic flash (Y), it is judged that “there exists back print 2 information”. Thus, the red eye correction processing is selected, and information showing that the red eye correction processing is executed is set as the second back print information (step S53). On the other hand, when the images were photographed not using an electronic flash (N), the red eye correction processing is not selected and it is judged that “there exists no back print 2 information” (step S54).

In the case of the scratch removal processing, as shown in FIG. 9C, information of image data, that is, image data is read in (step S61) and it is judged whether the image data is scratch removal processing target image data or not based on information showing whether the image data is acquired from a film or is digital image data from the DIC 20 (step S62). When the image data is acquired from a film, it is judged that the image data is processing target image data (Y), and it is judged that “there exists back print 2 information”. Thus, the scratch removal processing is selected, and information showing that the scratch removal processing is executed is set as the second back print information (step S63). On the other hand, when the image data is digital image data from the DIC 20, it is judged that the image data is not processing target image data (N), the scratch removal processing is not selected, and it is judged that “there exists no back print 2 information” (step S64).

Also, when designation of special finish processing, such as soft-focus processing and/or cross-filter processing, has been inputted, corresponding processing is selected. Note that a construction may be used in which selection of the sharpness processing and the like is also made in accordance with a customer's request.

Further, when an operator has judged as a result of observation of inspection images at the time of inspection that an electronic flash was used at the time of photographing or there exist image defects, image processing for correcting the defects may be selected in accordance with input of instructions by the operator.

A construction is also preferable in which when image defects have been detected as a result of analysis of prescan data, the preprocessing part selects image processing for correcting the image defects.

The preprocessing part determines every image processing selected in the manner described above as image processing that should be carried out on the images, and sends information showing the determined processing (kinds thereof) to the image processing part 28 and the back print information edit-and-output part 76. Alternatively, a construction may be used in which only image processing designated by the operator from among the image processing automatically selected by the preprocessing part is determined as image processing to be executed. When inspection is not performed, it is sufficient that every image processing selected by the preprocessing part is set as determined image processing and is executed at the image processing part 28. The back print information edit-and-output part 76 generates information showing that each selected processing is carried out as the second back print information.

The back print information edit-and-output part 76 generates back print recording information by editing the first back print information and the second back print information, and outputs it to the output apparatus 74 (step S308) using a method that is the same as the back print recording information generation method in the printers 10 and 60 shown in FIG. 5C.

The input apparatus 72 starts print image data creation processing and outputs information showing the print size of each image in a frame and the number of prints of the image to the output apparatus 74. In accordance with the information, the output apparatus 74 draws out and cuts the photosensitive material A (step S309).

Under control by the control system 38, when the print size of the first frame and the number of prints have been acquired, the output apparatus 74 starts supply of the photosensitive material A (step S309) like in the example described above. Following this, the output apparatus 74 records back prints on the photosensitive material A in accordance with the acquired back print recording information (step S310). The back prints include not only prints which are based on the first back print information and pursuant to a conventional standard but also prints which are based on the second back print information and show the image processing carried out on the print images. The format of the back prints corresponding to the second back print information is not specifically limited so long as it is possible to know the image processing carried out on the print images. For instance, it is possible to use each format that is the same as a format used in the first or second embodiment described above.

When inspection OK has been inputted and images have been determined, the input apparatus 72 operates in the same manner as in the embodiments described above. That is, in the case of a film, the input apparatus 72 performs fine scan (step S311) and performs image processing on obtained image data (step S312). Also, in the case of photographed image data by a digital camera or the like, the input apparatus 72 performs image processing on acquired image data (step S313).

The print images (image data for print output) having been subjected to the image processing are supplied from the input apparatus 72 to the output apparatus 74 (step S314). Based on the supplied print images, the output apparatus 74 performs scan-exposure with respect to the photosensitive material A having undergone the back printing, thereby recording images (step S315).

In the printer 70 in this embodiment, in the preprocessing process prior to the image processing process, it is determined whether high-grade processing, such as red eye correction processing, aberration correction processing, and scratch removal processing, is to be executed and information showing the execution/non-execution of the processing is generated as the second back print information. Therefore, it becomes possible to reduce a processing amount and a processing time necessary to generate the second back print information. As a result, as compared with a case where results of the high-grade image processing are contained in the second back print information like in the second embodiment described above, it becomes possible to further suppress lowering of print processing capacity.

Also, in the printer 70, when it has been determined to execute one or more high-grade processing as a result of the selection of execution/non-execution of each high-grade processing in the preprocessing process, the second back print information may be generated to contain information showing results of the image processing with the same method as in the second embodiment described above. When no high-grade processing has been selected, it may be judged that there exists no second back print information in the same manner as in the third embodiment described above and the processing may proceed to editing of the back print recording information. With the construction in which images subjected to high-grade processing are discriminated through the preprocessing and the second back print information containing image processing results is generated only for the images, it becomes possible to reflect the results of the high-grade processing, such as red eye correction, aberration correction, and scratch removal, in back prints while minimizing lowering of the print processing capacity.

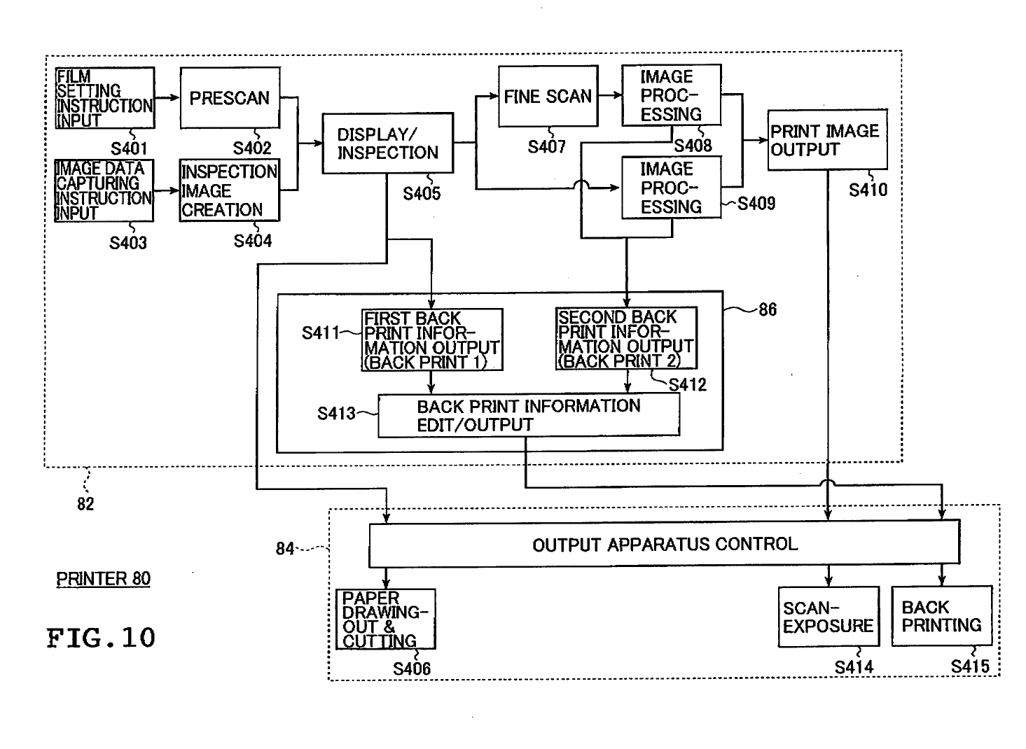

Next, a fourth embodiment of the present invention will be described. FIG. 10 is a diagram for explanation of an action of a printer 80 of the fourth embodiment in the present invention. The printer 80 differs from the printer 60 shown in FIGS. 6 and 7 in that back printing is performed (step S415) after image formation through scan-exposure of a photosensitive material A (step S414) at an output apparatus 84, and other constructions and actions of the printer 80 are the same as those of the printer 60 shown in FIGS. 6 and 7. That is, processing of steps S401 to S413 of the printer 80 respectively corresponds to the processing of steps S201 to S213 of the-printer 60 shown in FIG. 7.

In the printer 80, the back printer 34 is arranged on a downstream side in a conveying direction of the photosensitive material A with respect to the image forming unit (exposure unit 36).

In the printer 80, when image processing by an input apparatus 82 has been ended (step S408 or S409), print image data is outputted to the output apparatus 84 (step S410) and the photosensitive material A supplied to a scan-exposure position is exposed at the output apparatus 84 (step S414). During the operation, back print recording information is generated by a back print information edit-and-output part 86 using second back print information containing image processing results, and is outputted to the output apparatus 84 (step S413). At the output apparatus 84, back prints are recorded on the back surface of the exposed photosensitive material A (step S415).

With the construction in which exposure of the photosensitive material A is performed immediately after print image data has been supplied, and then recording of back prints with reference to back print recording information is performed, even when the second back print information is generated after image processing results have been acquired, it becomes possible to avoid or minimize occurrence of a waiting time of the output apparatus and achieve a further reduction of the first print time.

It should be noted here that also in the printer 70 shown in FIG. 8, the construction of the printer 80 may be used in which the back printer is arranged on the downstream side in the conveying direction of the photosensitive material A with respect to the image forming unit (exposure unit), and the back printing is performed after the image formation through the scan-exposure of the photosensitive material A.

In each embodiment described above, a construction has been described in which information concerning image processing is back-printed on back surfaces of prints, but the present invention is not limited to this. For instance, when all prints corresponding to one print order have been outputted, a front print or an index print may be outputted as an information recording sheet and information concerning image processing carried out on respective images of the prints corresponding to the print order may be expressed on the front print or the index print based on second back print information. In this case, it is sufficient that the back print of each print is a conventional back print based on first back print information.

When second back print information is expressed on a front print or an index print in the manner described above, it becomes sufficient that data for recording is generated from the second back print information during creation of prints corresponding to one print order, so there will not occur a waiting time of the output apparatus due to back printing, which makes it possible to reflect results of high-grade processing, such as red eye correction, aberration correction, and scratch removal, in back prints while maintaining print processing capacity.

In each embodiment described above, the printer (10 or the like) includes only one output apparatus (14 or the like), however, the present invention is not limited to this and multiple output apparatuses (14 or the like) may be connected to one input apparatus (12 or the like).

In this case, for instance, in the flowchart shown in FIG. 5C, image attribute information (for instance, information for designating the surface type of the recording medium A) is acquired together with first back print information (back print 1) through operator's instruction input or the like. Then, at the time of output, the information is associated with corresponding print images, and back print recording information is outputted to an output apparatus (14 and the like) selected in accordance with the attribute information. Note that it is sufficient that outputting of the print images to the output apparatus (14 or the like) is performed in the same manner as in the case of a print system including multiple output apparatuses (14 or the like).

The printer according to the present invention has been described in detail above, but the present invention is not limited to the embodiments described above, and it is of course possible to make various modifications and changes without departing from the gist of the present invention.

For instance, in the embodiments described above, the present invention is applied to a digital photoprinter, but it is possible to apply the present invention to another printer, such as a printer that reproduces images by electrophotography, a printer that reproduces images through ink jetting, a printing apparatus, a printer that uses a photosensitive recording medium, a printer that uses a thermal recording medium, or a printer that uses a photosensitive thermal recording medium, and perform back printing corresponding to first back print information and second back print information on the back surface of a recording medium on which a print (hard copy) is formed using the printer.

What is claimed is:

1. A printer, comprising:
an acquisition unit that acquires image data;
a display device that displays a finish prediction image of the image data;
an adjustment part that adjusts the finish prediction image;
an image processing part that generates image data for output by executing image processing in which an adjustment by said adjustment part is reflected on the image data;
a back print information edit-and-output part that generates first back print information containing information as to an adjustment by said adjustment part and second back print information that is information corresponding to image processing executed by said image processing part, edits the first back print information and the second back print information to generate back print recording information, and outputs the back print recording information;
an image forming unit that reproduces a visible image on a recording medium in accordance with the image data for output; and
a back printer that performs back printing corresponding to the back print recording information on a back surface of the recording medium.

2. The printer according to claim 1,
wherein said image processing part has a function of executing at least one of red eye correction, correction of an image defective portion, correction of aberration ascribable to a photographing lens, correction of deteriorated marginal luminosity ascribable to the photographing lens, trimming, soft-focus processing and cross-filter processing, in addition to a function of executing gradation correction, color/density correction, color saturation correction, sharpness processing, graininess suppression processing and dodging processing, and
wherein the second back print information is information concerning at least one of the sharpness processing, the graininess suppression processing, the dodging processing, the red eye correction, the image defective portion correction, the aberration correction, the deteriorated marginal luminosity correction, the trimming, the soft-focus processing and the cross-filter processing.

3. The printer according to claim 2, further comprising:
a selection part that collectively selects execution/non-execution of every function set in said image processing part among the red eye correction, the image defective portion correction, the aberration correction, and the deteriorated marginal luminosity correction.

4. The printer according to claim 2, further comprising:
a selection part that individually selects execution/non-execution of the red eye correction, the image defective portion correction, the aberration correction, and the deteriorated marginal luminosity correction.

5. The printer according to claim 1,
wherein said back printer prints information showing that an image processing has been executed based on the second back print information contained in the back print recording information.

6. The printer according to claim 5,
wherein said back printer prints information that-shows a processing content of at least one of the image processing executed, in addition to the information showing that the image processing has been executed, based on the second back print information contained in the back print recording information.

7. The printer according to claim 6,
wherein said back printer prints a content which is different depending upon a kind of the image processing executed as the information that shows a processing content based on the second back print information contained in the back print recording information.

8. The printer according to claim 1, further comprising:
a print information acquisition unit that acquires print information containing information showing a size and number of prints to be outputted;
a determination part that determines an image to be outputted; and
a supply part that acquires the information showing a size and number of prints acquired by said print information acquisition unit and supplies a corresponding recording medium, in response to image determination by said determination part,
wherein said image processing part generates the image data for output from the image data in response to the image determination by said determination part.

9. The printer according to claim 8,
wherein said determination part is a predetermined output instruction part, and
wherein an image is determined when an output instruction has been issued by the output instruction part after displaying of the finish prediction image.

10. The printer according to claim 8,
wherein said back print information edit-and-output-part generates the second back print information in accordance with a result of the image processing executed by said image processing part.

11. The printer according to claim 8, further comprising a selection part that selects image processing executed on the image data with reference to at least one of the print information acquired by said print information acquisition unit and information concerning the image,
wherein said back print information edit-and-output part generates the second back-print information in accordance with a result of selection by said selection part.

12. The printer according to claim 11,
wherein the information concerning the image contains at least one of photographing information, camera information, and image data.

13. The printer according to claim 8,
wherein the print information contains information showing designation of image processing by said image processing part.

14. A print, comprising:
a front surface on which an image has been reproduced; and
a back surface on which information corresponding to image processing executed on the image has been printed,
wherein the information corresponding to image processing is information concerning at least one of sharpness processing, graininess suppression processing, dodging processing, red eye correction, image defective portion correction, aberration correction, deteriorated marginal luminosity correction, trimming, soft-focus processing, and cross-filter processing.

15. The print according to claim 14,
wherein the information corresponding to image processing contains information showing that the image processing has been executed on the image.

16. The print according to claim 15,
wherein the information corresponding to image processing contains information showing a processing content of at least one of the image processing executed, in addition to the information showing that the image processing has been executed on the image.

17. The print according to claim 16,
wherein the information showing a processing content is different depending upon a kind of the image processing executed on the image.
